(19) United States
(12) Patent Application Publication
(10) Pub. No.: US 2025/0189959 A1
(43) Pub. Date: Jun. 12, 2025

(54) ANOMALY DIAGNOSIS DEVICE, ANOMALY DIAGNOSIS METHOD, AND STORAGE MEDIUM

(71) Applicant: Mitsubishi Electric Corporation, Chiyoda-ku, Tokyo (JP)

(72) Inventors: Kimiaki UEMURA, Tokyo (JP); Motoaki TAMAYA, Tokyo (JP); Takashi YOSHIOKA, Tokyo (JP); Yuichi IKEDA, Tokyo (JP); Nobuaki TANAKA, Tokyo (JP)

(73) Assignee: Mitsubishi Electric Corporation, Chiyoda-ku, Tokyo (JP)

(21) Appl. No.: 18/846,355

(22) PCT Filed: Mar. 3, 2023
(86) PCT No.: PCT/JP2023/008102

§ 371 Date: Sep. 12, 2024

(30) Foreign Application Priority Data
Apr. 7, 2022 (JP) 2022-064158

(51) Int. Cl. G05B 23/02

(52) U.S. Cl. CPC G05B 23/0221; G05B 23/0227

(57) ABSTRACT

An anomaly diagnosis device includes a signal processing device. The signal processing device includes a signal processing unit, a data storage unit, and a determination unit. The signal processing unit performs STFT on waveform data of an input signal, and calculates feature quantities. The data storage unit stores feature quantity data based on data of a known normal waveform. The determination unit compares first feature quantity data consisting of multiple ones of the feature quantities calculated by the signal processing unit with second feature quantity data, which is the feature quantity data stored in the data storage unit, and determines acceptability of the waveform data of the input signal. The feature quantities are each a quantity representing the degree of non-uniformity in temporal change of spectral intensity of a specific frequency band included in waveform data.

### FIELD

The present disclosure relates to an anomaly diagnosis device, an anomaly diagnosis method, and an anomaly diagnosis program each for diagnosing an anomaly of an electrical device.

### BACKGROUND

In a typical assembly process of an electrical device, an operation test is performed on the electrical device during or after completion of the assembly process. In addition, a sensory test is performed during the operation test to confirm acceptability of the electrical device in terms of whether there is no anomaly in a vibration or an operation sound generated from the electrical device. Such sensory test is performed using auditory sense or tactile sense of the operator, and is therefore characterized in dependency on the sense of the operator. Thus, to quantify information concerning a vibration or an operation sound used as the basis for determining acceptability, the sensory test is sometimes performed using a diagnostic device that converts the information concerning the vibration or the operation sound obtained by a device such as a microphone or a vibration sensor, into waveform data, and performs signal processing on the waveform data.

Patent Literature 1 described below discloses a technology in which a comparison is made between a spectrum pattern obtained by performing fast Fourier transform (FFT) processing on waveform data of a vibration generated from an electrical device and a preset known spectrum pattern in an anomalous case, and a diagnosis is made of whether the electrical device is in an anomalous condition on the basis of the comparison result.

### CITATION LIST

### Patent Literature

Patent Literature 1: Japanese Patent Application Laid-open No. S62-93620

### SUMMARY OF INVENTION

### Problem to be Solved by the Invention

As described above, the technology of Patent Literature 1 mentioned above makes a determination of an anomaly using only a spectrum pattern. The technology of Patent Literature 1 accordingly presents a problem in difficulty in determination of the type of anomaly in a case where different types of anomalies show a same spectrum pattern, for example, when anomalies have a same spectrum pattern as each other, but occur at intervals different from each other. In addition, the technology of Patent Literature 1 mentioned above allows a determination to be made about a known anomaly such as one having a spectrum pattern of waveform data that changes over time, but presents a problem in difficulty in making a determination about an unknown anomaly different from an anomaly usually sensed by the operator.

The present disclosure has been made in view of the foregoing, and it is an object of the present disclosure to provide an anomaly diagnosis device capable of determining known and unknown anomalies different from a usual anomaly.

### Means to Solve the Problem

To solve the problem and achieve the object described above, an anomaly diagnosis device according to the present disclosure includes a microphone that converts a sound from a determination target into an analog electrical signal, and a signal converter that converts the analog electrical signal into a digital signal. A signal processing device that receives the digital signal and performs signal processing includes a signal processing unit, a data storage unit, and a determination unit. The signal processing unit performs short-time fast Fourier transform on waveform data of an input signal, and calculates feature quantities. The data storage unit stores feature quantity data based on data of a known normal waveform. The determination unit compares first feature quantity data with second feature quantity data, and determines acceptability of the waveform data of the input signal, where the first feature quantity data consists of multiple ones of the feature quantities calculated by the signal processing unit, and the second feature quantity data is the feature quantity data stored in the data storage unit. The feature quantities are each a quantity representing a degree of non-uniformity in temporal change of spectral intensity of a specific frequency band included in waveform data.

### Effects of the Invention

An anomaly diagnosis device according to the present disclosure provides an advantage in capability of determining known and unknown anomalies different from a usual anomaly.

### BRIEF DESCRIPTION OF DRAWINGS

FIG. 1 is a block diagram illustrating an exemplary configuration of an anomaly diagnosis device according to a first embodiment.

FIG. 2 is a diagram for describing a filter bank operation applicable to a signal processing device according to the first embodiment.

FIG. 3 is a flowchart for describing an anomaly diagnosis method to be used for an electrical device, using the anomaly diagnosis device according to the first embodiment.

FIG. 4 is a block diagram illustrating an exemplary configuration of an anomaly diagnosis device according to a second embodiment.

FIG. 5 is a block diagram for describing an algorithm of an estimation process for use in the second embodiment.

FIG. 6 is a block diagram illustrating an exemplary configuration of an anomaly diagnosis device according to a third embodiment.

FIG. 7 is a block diagram illustrating an exemplary configuration of an anomaly diagnosis device according to a fourth embodiment.

FIG. 8 is a block diagram illustrating an exemplary configuration of an anomaly diagnosis device according to a sixth embodiment.

FIG. 9 is a diagram for describing a procedure of removal of known noise, performed using the anomaly diagnosis device according to the sixth embodiment.

### DESCRIPTION OF EMBODIMENTS

An anomaly diagnosis device, an anomaly diagnosis method, and an anomaly diagnosis program according to embodiments of the present disclosure will be described in detail below with reference to the accompanying drawings. Note that the embodiments described below are provided as examples, and the scope of the present disclosure is not limited by the following embodiments.

### First Embodiment

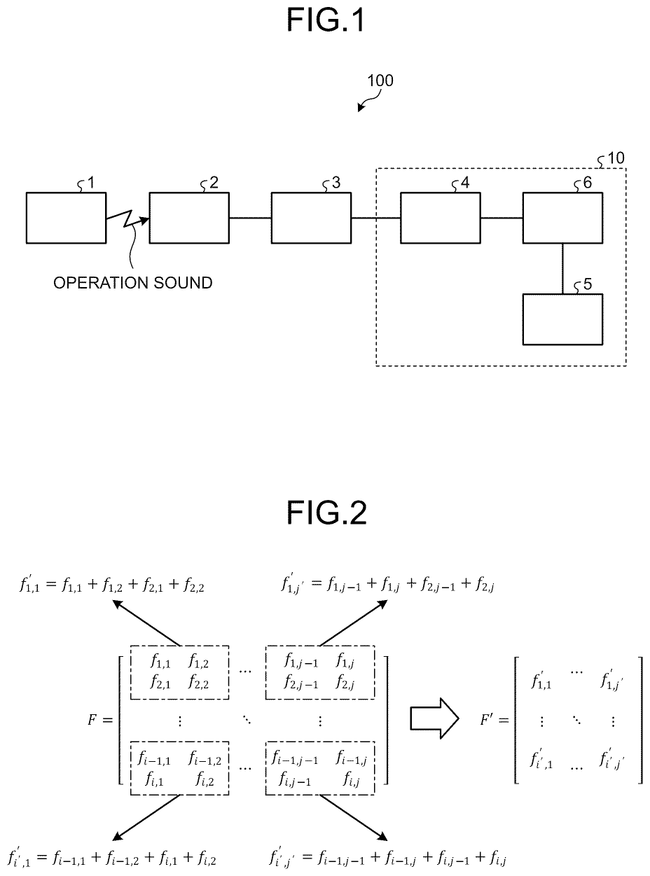

FIG. 1 is a block diagram illustrating an exemplary configuration of an anomaly diagnosis device according to a first embodiment. An anomaly diagnosis device 100 according to the first embodiment includes a microphone 2, a signal converter 3, and a signal processing device 10. In addition, the signal processing device 10 includes a signal processing unit 4, a data storage unit 5, and a determination unit 6.

The microphone 2 converts a sound including an operation sound of a determination target 1 into an analog electrical signal. The signal converter 3 is an analog-to-digital (AD) converter, which converts the analog electrical signal output from the microphone 2 into a digital signal. The signal processing device 10 receives the digital signal output from the signal converter 3 and performs signal processing described later. Note that the anomaly diagnosis device 100 may include multiple ones of the signal processing device 10.

In the signal processing device 10, the signal processing unit 4 performs necessary computation on waveform data of an input signal to calculate feature quantities. The feature quantities are each a quantity representing the degree of non-uniformity in temporal change of spectral intensity of a specific frequency band included in the waveform data, in other words, how greatly the amount of change in spectral intensity of a specific frequency band varies in a time elapse direction.

The data storage unit 5 stores feature quantity data based on data of a known normal waveform. The determination unit 6 compares feature quantity data consisting of multiple ones of the feature quantities calculated by the signal processing unit 4 with the feature quantity data based on data of a known normal waveform, stored in the data storage unit 5, and determines acceptability of the waveform data of the input signal input to the signal processing device 10.

Note that a data group consisting of multiple ones of the feature quantities calculated by the signal processing unit 4 may be referred to herein as “first feature quantity data”, and the feature quantity data, or a set of the feature quantity data, based on data of a known normal waveform, stored in the data storage unit 5 may be referred to herein as “second feature quantity data”.

The microphone 2 can be a commonly-used general-purpose microphone, but desirably prevents an ambient noise from being included to a maximum possible extent in the operation sound generated from the determination target 1. This can be achieved by use of a sound collecting microphone having sound collection directivity, use of a parabolic-type sound collecting microphone combining a commonly-used microphone and a parabolic reflection plate, or use of an appropriate combination of these types of sound collecting microphones.

The signal converter 3 can be a commonly-used audio interface. In this respect, use of an audio interface having a high sampling frequency is desirable because this allows a wide range in the frequency direction to be used in an FFT operation performed in the signal processing described later. Note that when the signal processing device 10 has functionality equivalent to the functionality of the signal converter 3, such functionality may be used.

Processing of the signal processing device 10 can be performed using a commonly-used computer or programmable logic controller (PLC). A PLC is also called sequencer. Alternatively, processing of the signal processing device 10 may be performed using an electronic circuit board including a device for signal processing and a storage medium. Examples of the device for signal processing include a microcomputer and a field programmable gate array (FPGA), and examples of the storage medium include non-volatile and volatile semiconductor memories such as a random access memory (RAM), a flash memory, an erasable programmable read-only memory (EPROM), and an electrically erasable programmable read-only memory (EEPROM) (registered trademark). The signal processing device 10 is capable of performing a sequence of operations according to a procedural process, from reception of waveform data up to the determination. The signal processing device 10 may further include a screen that allows specification of, and can display, the status of determination. In this case, the operator is allowed to configure settings required for determination processing using the screen, and the state of determination and a result thereof can be displayed on the screen for informing the operator of such information.

An algorithm of determination processing for use in the signal processing device 10 will next be described. The signal processing unit 4 performs short-time fast Fourier transform (STFT) on the waveform data obtained by the conversion performed by the signal converter 3. In STFT, the waveform data is divided into an arbitrary number of blocks in each of a frequency direction and a time direction. The result of the STFT processing is expressed by a matrix F having “i” frequency dimensions and “j” time dimensions expressed by Equation (1) below.

$$Formula 1$$

$$F = [ \begin{matrix}{f}_{1 , 1} & ⋯ & {f}_{1 , j} \\ ⋮ & ⋱ & ⋮ \\ {f}_{i , 1} & ⋯ & {f}_{i , j}\end{matrix} ] \qquad ( 1 )$$

In Equation (1) above, “i” represents the number of divisions of the waveform data in the frequency direction, and “j” represents the number of divisions of the waveform data in the time direction.

In addition, the signal processing unit 4 calculates a feature quantity vector T expressed by Equation (2) below, whose elements are feature quantities, which are the standard deviations of spectral intensity in the time direction in the matrix F, on the basis of the matrix F, which is the result of the STFT processing.

$$Formula 2$$

$$T = \vert \begin{matrix}{t}_{1} \\ ⋮ \\ {t}_{i}\end{matrix} \vert \qquad ( 2 )$$

In Equation (2) above, a feature quantity t at an arbitrary frequency i among the elements t₁, . . . , and tᵢ of the feature quantity vector T is calculated by Equation (3) below.

$$Formula 3$$

$$t = \sqrt{\frac{1}{j} {\sum }_{n = 1}^{j} {( {f}_{i , n} - {\tilde{f}}_{l} )}^{2}} \qquad ( 3 )$$

In Equation (3) above, “f⁻” is an alternative expression representing a character “f” having a symbol “⁻” thereabove. In addition, “f⁻ₗ” represents the average value of the j elements f_{i,l}, . . . , and f_{i,j} of the i-th row of Equation (1) above.

As described above, the data storage unit 5 stores the feature quantity data based on data of a known normal waveform. The feature quantity data stored in the data storage unit 5 is also calculated by STFT. Now, let k denote the number of sets of the data of a known normal waveform, and let T′ₖ denote a set of feature quantities based on the multiple sets of the data of a known normal waveform. T′ₗ is a feature quantity vector calculated using waveform data 1, which is first waveform data, and T′ₖ is a feature quantity vector calculated using waveform data k, which is k-th waveform data. In addition, data of an average υ and of a standard deviation σ of the set T′ₖ is referred to herein as second feature quantity data. The average υ and the standard deviation σ can be expressed by Equations (4) and (5) below. In this respect, the value of k, which is the number of sets of the data of a known normal waveform, is desirably at least 100 or higher.

$$Formula 4$$

$$v = [ \begin{matrix}\frac{1}{k} {\sum }_{n = 1}^{k} {T}_{1}^{′} \\ ⋮ \\ \frac{1}{k} {\sum }_{n = 1}^{k} {T}_{i}^{′}\end{matrix} ] \qquad ( 4 )$$

$$Formula 5$$

$$σ = [ \begin{matrix}\sqrt{\frac{1}{k} {\sum }_{n = 1}^{k} {( {T}_{1}^{′} - \frac{1}{k} {\sum }_{n = 1}^{k} {T}_{1}^{′} )}^{2}} \\ ⋮ \\ \sqrt{\frac{1}{k} {\sum }_{n = 1}^{k} {( {T}_{i}^{′} - \frac{1}{k} {\sum }_{n = 1}^{k} {T}_{i}^{′} )}^{2}}\end{matrix} ] \qquad ( 5 )$$

Note that the average υ and the standard deviation σ expressed by Equations (4) and (5) above are herein given as an example of the second feature quantity data. A statistic other than the average υ and the standard deviation σ may be stored in the data storage unit 5 as the second feature quantity data.

As described above, the determination unit 6 determines acceptability of the waveform data of the input signal that has been input. This determination processing uses a determination metric Zᵢ expressed by Equation (6) below.

$$Formula 6$$

$${Z}_{i} = \frac{{T}_{i} - {v}_{i}}{{σ}_{i}} \qquad ( 6 )$$

The determination metric Zᵢ is used to determine the degree of discrepancy between the first feature quantity data and the second feature quantity data. The determination unit 6 compares the value of the determination metric Zᵢ with a predetermined threshold on a per-frequency band basis, and when at least one or some of the values of the determination metric Zᵢ is greater than the threshold, the determination unit 6 determines that the waveform data subjected to determination has an anomaly or is in a state deviating from a normal state.

Note that, in the STFT processing described above, a filter bank operation illustrated in FIG. 2 may be used in combination. FIG. 2 is a diagram for describing a filter bank operation applicable to the signal processing device according to the first embodiment.

The filter bank operation is an operation in which the matrix F, which is the result of the STFT processing, is divided into i′ (i′<i) blocks of the waveform data in the frequency direction, and is divided into j′ (j′<j) blocks of the waveform data in the time direction. Specifically, FIG. 2 illustrates an example when i′=i/2 and j′=j/2.

As illustrated in the left-side diagram of FIG. 2, an operation of f_{1,1}+f_{1,2}+f_{2,1}+f_{2,2}, i.e., an addition operation, is performed on the four elements f_{1,1}, f_{1,2}, f_{2,1}, and f_{2,2} in the upper-left portion of the matrix F, the result of which is denoted by f′_{1,1}. Similar operations are performed in which an operation of f_{1,j-1}+f_{1,j}+f_{2,j-1}+f_{2,j} is performed on the four elements f_{1,j-1}, f_{1,j}, f_{2,j-1}, and f_{2,j} on the upper-right portion of the matrix F, the result of which is denoted by f′1,j′; an operation of f_{1-1,1}+f_{1-1,2}+f_{1,1}+f_{1,2} is performed on the four elements f_{1-1,1}, f_{1-1,2}, f_{1,1}, and f_{1,2} on the lower-left portion of the matrix F, the result of which is denoted by f′_{1′,1}; an operation of f_{1-1,j-1}+f_{1-1,j}+f_{1,j-1}+f_{1,j} is performed on the four elements f_{1-1,j-1}, f_{1-1,j}, f_{1,j-1}, and f_{1,j} on the lower-right portion of the matrix F, the result of which is denoted by f′_{1′,j′}; and addition operations are also performed on the other elements of the matrix F in units of four elements. A reunified new matrix F′ illustrated in the right-side diagram of FIG. 2 is thus generated.

Note that the operation illustrated in FIG. 2 is merely by way of example, and any values can be selected as the values of i′ and j′ that satisfy relationships of i′<i and j′<j. In addition, the waveform data does not necessarily need to be divided into equal-width blocks. This means that the number of divisions i′ does not need to be a divisor of the number of divisions i, or the number of divisions j′ does not need to be a divisor of the number of divisions j. Moreover, there is no dependency between the number of divisions in the frequency direction and the number of divisions in the time direction, and the waveform data can be divided independently of the direction of division.

Appropriately setting the numbers of divisions i′ and j′ allows the feature of the sound from the determination target 1 to be emphasized in the reunified matrix F′. Thus, use of the reunified matrix F′ obtained using the filter bank operation can improve accuracy of the determination of acceptability of the waveform data.

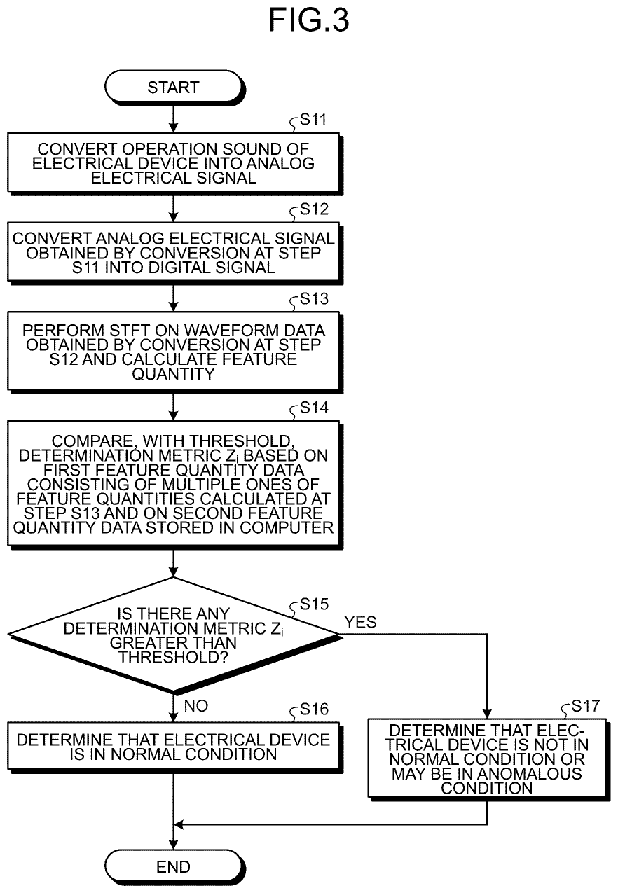

FIG. 3 is a flowchart for describing an anomaly diagnosis method to be used for an electrical device, using the anomaly diagnosis device according to the first embodiment. The process flow of FIG. 3 can be performed using a computer, a PLC, or a processor including a storage unit. Such computer, PLC, or processor is referred to hereinafter simply as “computer”.

The computer stores the second feature quantity data, i.e., data of feature quantities each representing the degree of non-uniformity in temporal change of spectral intensity of a specific frequency band included in the data of a known normal waveform. The computer further stores a program for providing the functionality of each of the microphone 2, the signal converter 3, and the signal processing device 10 described above. Alternatively, the computer is configured to enable such program to be loaded externally thereof and executed.

The computer converts an operation sound of an electrical device into an analog electrical signal (step S11). The computer converts the analog electrical signal obtained by the conversion at step S11 into a digital signal (step S12). The computer performs STFT on the waveform data obtained by the conversion at step S12, and calculates feature quantities (step S13).

The computer compares a value of the determination metric Zᵢ with a threshold. The determination metric Zᵢ is based on first feature quantity data consisting of multiple ones of the feature quantities calculated at step S13 and on second feature quantity data stored in the computer (step S14). Details of the operation at step S14 is as follows. As described above, the feature quantity vector T representing the first feature quantity data is expressed by Equation (2) above, and the feature quantity vector T has elements each expressed by Equation (3) above. In addition, an example of the determination metric Zᵢ is expressed by Equation (6) above.

The computer determines whether any value of the determination metric Zᵢ is greater than the threshold (step S15). When no value of the determination metric Zᵢ is greater than the threshold (step S15, No), the computer determines that the electrical device is in a normal condition (step S16). Alternatively, when at least one value of the determination metric Zᵢ is greater than the threshold (step S15, Yes), the computer determines that the electrical device is not in a normal condition or may be in an anomalous condition (step S17).

Use of the flowchart of FIG. 3 enables determination of whether an electrical device subjected to the determination is a normal product or a defective product. Note that the computer desirably has functionality to draw and display a graph illustrating the value of the determination metric Zᵢ and the threshold on a display screen. This functionality enables the operator to be visually and easily informed of the result of determination of acceptability of waveform data.

As also described in the section of “Problem to be solved by the Invention”, the conventional technology makes a determination of an anomaly using only a spectrum pattern, which presents a problem in difficulty in determining the type of anomaly for anomalies having a same spectrum pattern as each other, but occurring at intervals different from each other. The conventional technology also presents a problem in difficulty in making a determination about an unknown anomaly different from an anomaly usually sensed by the operator. In contrast, the anomaly diagnosis method according to the first embodiment determines whether the waveform data subjected to determination has an anomaly on the basis of the degree of discrepancy between a feature quantity of the waveform data subjected to determination and a feature quantity of data of a known normal waveform stored in the computer. This enables determination of acceptability of the waveform data to be made even for an unknown anomaly.

Note that although the above description has been provided assuming that the computer stores feature quantities of the data of a known normal waveform, the present disclosure is not limited thereto. It is sufficient that feature quantities of the data of a known normal waveform can be referred to by the computer, and such feature quantities may be held in a storage unit or in a storage area that is no component of the computer. That is, it is sufficient that the computer be configured to be able to refer to the feature quantities of the data of a known normal waveform.

As described above, the anomaly diagnosis device according to the first embodiment includes a microphone that converts a sound from a determination target into an analog electrical signal, and a signal converter that converts the analog electrical signal into a digital signal. The signal processing device, which receives the digital signal and performs signal processing, includes a signal processing unit, a data storage unit, and a determination unit. The signal processing unit performs short-time fast Fourier transform on waveform data of an input signal, and calculates feature quantities. The data storage unit stores feature quantity data based on data of a known normal waveform. The determination unit compares first feature quantity data with second feature quantity data, and determines acceptability of the waveform data of the input signal, where the first feature quantity data consists of multiple ones of the feature quantities calculated by the signal processing unit, and the second feature quantity data is the feature quantity data stored in the data storage unit. The feature quantities are each a quantity representing the degree of non-uniformity in temporal change of spectral intensity of a specific frequency band included in the waveform data. The anomaly diagnosis device configured in such a manner determines whether the waveform data subjected to determination has an anomaly on the basis of the degree of discrepancy between the feature quantities of the waveform data subjected to determination and the feature quantities of the data of a known normal waveform, stored in the data storage unit. This enables determination of known and unknown anomalies different from a usual anomaly such as one in which the spectrum pattern changes over time.

Note that, in the foregoing operation, the signal processing device may perform a filter bank operation on the feature quantities generated through short-time fast Fourier transform, and then generate the first feature quantity data on the basis of the feature quantities obtained through the filter bank operation. This enables the width in the time direction or the width in the frequency direction to be arbitrarily changed in obtaining the first feature quantity data. This can improve accuracy of the determination of acceptability of the waveform data.

In addition, the anomaly diagnosis method according to the first embodiment is a method for diagnosing an anomaly of an electrical device using a computer configured to be able to refer to a feature quantity representing the degree of non-uniformity in temporal change of spectral intensity of a specific frequency band included in data of a known normal waveform. This anomaly diagnosis method includes first through fourth steps described below. The first step is a step of converting an operation sound of the electrical device into an analog electrical signal. The second step is a step of converting the analog electrical signal into a digital signal. The third step is a step of performing short-time fast Fourier transform on waveform data obtained by the conversion performed in the second step, and of calculating feature quantities. The fourth step is a step of comparing first feature quantity data consisting of multiple ones of the feature quantities calculated in the third step with second feature quantity data stored in the computer, and of determining acceptability of the waveform data. Causing the computer to perform the first through fourth steps enables determination of known and unknown anomalies different from a usual anomaly such as one in which the spectrum pattern changes over time.

Moreover, an anomaly diagnosis program according to the first embodiment is a program that causes a computer to diagnose an anomaly of an electrical device, where the computer is configured to be able to refer to a feature quantity representing a degree of non-uniformity in temporal change of spectral intensity of a specific frequency band included in data of a known normal waveform. This anomaly diagnosis program includes first through fourth steps described below. The first step is a step of converting an operation sound of the electrical device into an analog electrical signal. The second step is a step of converting the analog electrical signal into a digital signal. The third step is a step of performing short-time fast Fourier transform on waveform data obtained by the conversion performed in the second step, and of calculating feature quantities. The fourth step is a step of comparing first feature quantity data consisting of multiple ones of the feature quantities calculated in the third step with second feature quantity data stored in the computer, and of determining acceptability of the waveform data. Causing the computer to execute the program including the first through fourth steps enables determination of known and unknown anomalies different from a usual anomaly such as one in which the spectrum pattern changes over time.

### Second Embodiment

The configuration of the anomaly diagnosis device according to the first embodiment illustrated in FIG. 1 may allow an ambient noise to enter, and may cause the noise to be misidentified as an anomalous sound. An improved configuration for preventing such situation will be proposed as a second embodiment.

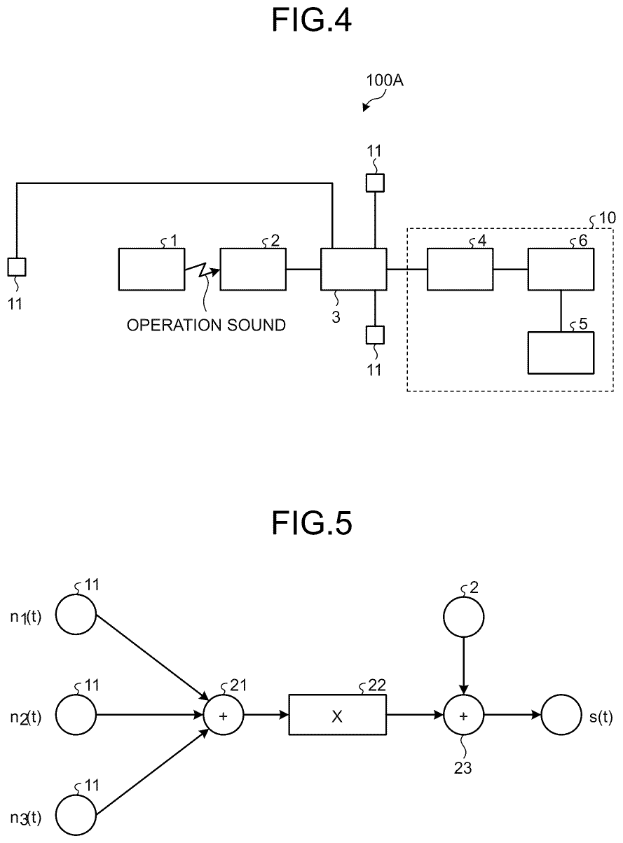

FIG. 4 is a block diagram illustrating an exemplary configuration of an anomaly diagnosis device according to the second embodiment. In FIG. 4, an anomaly diagnosis device 100A according to the second embodiment additionally includes noise collecting microphones 11 for collecting ambient noise as compared to the configuration of the anomaly diagnosis device 100 according to the first embodiment illustrated in FIG. 1. The other components are identical or equivalent to the components illustrated in FIG. 1. The identical or equivalent components are designated by like reference characters, and duplicate description will be omitted. Note that FIG. 4 illustrates a case of three noise collecting microphones 11 as an example, but the configuration is not limited thereto. The number of the noise collecting microphones 11 may be one or plural, i.e., two or four or more.

An operation of the anomaly diagnosis device according to the second embodiment will next be described. As described above, the configuration in the first embodiment may allow an ambient noise to enter, and may cause the noise to be misidentified as an anomalous sound. The anomaly diagnosis device according to the second embodiment accordingly estimates the time section in which ambient noise is present, using waveform data collected using the noise collecting microphones 11. The technique described in the first embodiment is then applied to waveform data obtained by removal of the time section estimated. Such operation can provide a determination technique that reduces the effect of ambient noise.

An algorithm of an estimation process to be used in the second embodiment will next be described with reference to FIG. 5. FIG. 5 is a block diagram for describing an algorithm of an estimation process for use in the second embodiment. FIG. 5 illustrates adders 21 and 23 and a filter 22 as control elements for providing a technique of the second embodiment.

First, assume that the matrix F expressed by Equation (1) above and the feature quantity vector T expressed by Equation (2) above have been obtained from waveform data of audio signals collected by the microphone 2 and by the noise collecting microphones 11. In this situation, let s(t) denote a feature vector obtained from the microphone 2, and n₁(t), n₂(t), and n₃(t) denote respective feature vectors obtained from the three noise collecting microphones 11.

In FIG. 5, the filter 22 only needs to reproduce the degree of attenuation of the value of each element of the matrix F. Now let w denote a constant vector representing characteristics of the filter 22, and let d″ (t) denote an estimated value set of the noise included in the feature vector s(t) observed by the microphone 2. The expression “d^{˜}” is an alternative expression representing a character “d” having a symbol “^{˜}” thereabove. In this condition, the estimated value set d^{˜}(t) of the noise can be expressed by Equation (7) below.

$$Formula 7$$

$$\tilde{d} ( t ) = w ° ( {n}_{1} ( t ) + {n}_{2} ( t ) + {n}_{3} ( t ) ) \qquad ( 7 )$$

In Equation (7) above, the symbol “^{∘}” is an operator of multiplication of each element of the vector. Note that the constant vector w representing the characteristics of the filter 22 is a vector whose elements are constants obtained by appropriately calculating the attenuation rate of each element. The attenuation rate of each element may be calculated in any manner.

Equation (7) above means that a feature quantity of the noise can be calculated by multiplication of a sum of sound pressure levels of the three noise collecting microphones 11, by a constant. Thus, a period in which a feature quantity of the noise calculated by Equation (7) above is greater than a predetermined threshold can be estimated to be the period in which a noise is present. Accordingly, making a determination using the above-mentioned algorithm after removing the estimated period, i.e., the period in which a noise is present, enables determination of acceptability of the waveform data having a reduced effect of noise that has entered.

Characteristics of the filter 22 will next be discussed. First, having good characteristics of the filter 22 is equivalent to a small error between the actual noise d(t) observed by the microphone 2 and the estimated value set d^{˜}(t) thereof. To consider this error, an observation signal matrix N expressed by Equation (8) below is defined.

$$Formula 8$$

$$N = ( \begin{matrix}{[ {n}_{1} ( 1 ) + {n}_{2} ( 1 ) + {n}_{3} ( 1 ) ]}^{T} \\ ⋮ \\ {[ {n}_{1} ( L ) + {n}_{2} ( L ) + {n}_{3} ( L ) ]}^{T}\end{matrix} ) \qquad ( 8 )$$

In Equation (8) above, the symbol “T” indicates transpose. In addition, L represents the number of frames in the observation signal matrix N. Note that the number of frames L corresponds to the number of short-time frames in STFT.

A noise matrix D expressed by Equation (9) below is further defined, which represents actual noise observed by the microphone 2.

$$Formula 9$$

$$D = ( \begin{matrix}{d ( 1 )}^{T} \\ ⋮ \\ {d ( L )}^{T}\end{matrix} ) \qquad ( 9 )$$

Now let Nᵢ denote an operation of extracting an i-th column of the observation signal matrix N expressed by Equation (8) above to generate a column vector, and let Di denote an operation of extracting an i-th column of the noise matrix D expressed by Equation (9) above to generate a column vector. Furthermore, let wᵢ denote an operation of extracting an i-th value of the constant vector w. With this notation, a square error “e” can be expressed as Equation (10) below, where “e” represents the square error for an i-th frequency in the matrix F, which represents the result of the STFT processing.

$$Formula 10$$

$$e = {( {D}_{i} - {w}_{i} {N}_{i} )}^{T} ( {D}_{i} - {w}_{i} {N}_{i} ) \qquad ( 10 )$$

A value of wᵢ that minimizes Equation (10) above is next calculated. This value of wᵢ is the value of wᵢ that causes (de/wᵢ), which is the derivative of Equation (10) above with respect to wᵢ, to reach zero, that is, the value of wᵢ satisfying de/wᵢ=0. This value is expressed by Equation (11) below.

$$Formula 11$$

$${w}_{i} = \frac{{N}_{i}^{T} {D}_{i}}{{N}_{i}^{T} {N}_{i}} \qquad ( 11 )$$

Performing the operation of Equation (11) above on all values of “i” enables the constant vector w having optimum parameter values to be obtained. Note that the operation processing described above requires information about the noise d(t) collected by the microphone 2 and information about the feature vectors n₁(t), n₂(t), and n₃(t) collected by the noise collecting microphones 11. Instead of this, an alternative technique can be used. An example of alternative technique is to use data recorded when only noise is present and no operation sound to be measured is present. In this technique, data may be used that has been generated by recording only noise in an actual noise environment, or data may be used that has been generated by recording a sound reproduced in a laboratory by a speaker from a signal corresponding to the noise. An example of the signal of the latter case can be an experimental signal having energy in all frequency bands and changing over time. An example of such experimental signal is a time-stretched-pulse (TSP) signal for use in a TSP method.

As described above, the anomaly diagnosis device according to the second embodiment further includes a noise collecting microphone for collecting ambient noise. The signal processing device estimates the time section in which ambient noise is present, using waveform data collected using the noise collecting microphone, performs short-time fast Fourier transform on waveform data obtained by removal of the time section estimated, and calculates feature quantities. This enables avoidance of misidentifying a noise included in a sound from the determination target as an anomaly.

In addition, the anomaly diagnosis method according to the second embodiment includes, between the second step and the third step of the anomaly diagnosis method described in the first embodiment, an estimation step of estimating the time section in which ambient noise is present, using waveform data collected using a noise collecting microphone for collecting ambient noise. Then, in the third step, short-time fast Fourier transform is performed on waveform data obtained by removal of the time section estimated in the estimation step, and the feature quantities are calculated. Such operation can provide a determination technique that reduces the effect of ambient noise. This enables avoidance of misidentifying a noise included in a sound from the determination target as an anomaly. Third Embodiment.

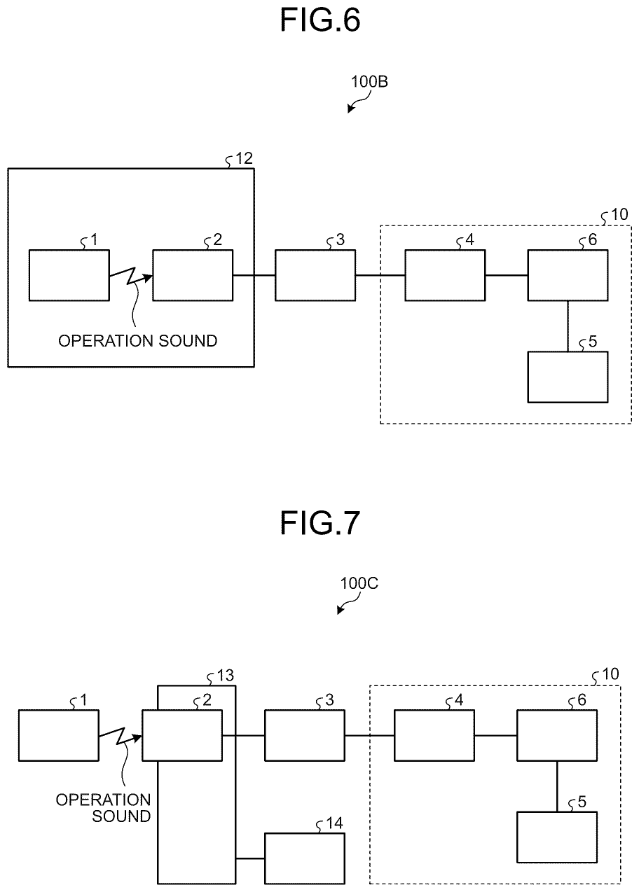

FIG. 6 is a block diagram illustrating an exemplary configuration of an anomaly diagnosis device according to a third embodiment. In FIG. 6, an anomaly diagnosis device 100B according to the third embodiment additionally includes sound insulation walls 12 for reducing ambient noise as compared to the configuration of the anomaly diagnosis device 100 according to the first embodiment illustrated in FIG. 1. The sound insulation walls 12 are arranged to surround the determination target 1. The other components are identical or equivalent to the components illustrated in FIG. 1. The identical or equivalent components are designated by like reference characters, and duplicate description will be omitted.

In the configuration of FIG. 6, the sound insulation walls 12 can each be a commonly-used acoustical material, a metal board, or a combination thereof. The sound insulation walls 12 desirably have a different thickness depending on the ambient noise intensity.

In the third embodiment, the technique of determining whether waveform data has an anomaly is basically similar to that of the first embodiment. However, the configuration of the first embodiment may allow ambient noise to enter. In addition, when in an environment where ambient noise cannot be completely removed or noise enters continuously, the configuration of the second embodiment may cause misidentification of the noise as an anomalous sound. In contrast, the configuration of the third embodiment can attenuate the ambient noise by the sound insulation walls 12. The technique of the third embodiment is simple, but can provide a determination technique that reduces the effect of ambient noise.

As described above, the anomaly diagnosis device according to the third embodiment includes sound insulation walls arranged to surround the determination target. The sound insulation walls attenuate ambient noise, thereby enabling a determination technique that reduces the effect of ambient noise to be provided. This enables avoidance of misidentifying a noise included in a sound from the determination target as an anomaly.

### Fourth Embodiment

FIG. 7 is a block diagram illustrating an exemplary configuration of an anomaly diagnosis device according to a fourth embodiment. In FIG. 7, an anomaly diagnosis device 100C according to the fourth embodiment additionally includes a movable unit 13 for moving the microphone 2, and a movable control unit 14, which controls movement of the movable unit 13, as compared to the configuration of the anomaly diagnosis device 100 according to the first embodiment illustrated in FIG. 1. The other components are identical or equivalent to the components illustrated in FIG. 1. The identical or equivalent components are designated by like reference characters, and duplicate description will be omitted.

In this configuration, the movable unit 13 can be a multi-joint robot, a linear robot, an air cylinder, an oil-hydraulic pressure cylinder, or the like. In addition, the movable control unit 14 can be a computer, a sequencer, or the like. The movable control unit 14 may include a position detection sensor, a camera, or the like for determining the movement of the movable unit 13.

In the fourth embodiment, the technique of determining whether waveform data has an anomaly is basically similar to that of the first embodiment. However, in a case where, for example, the determination target 1 is in motion in the first embodiment, a fixed position of the microphone 2 causes the distance between the determination target 1 and the microphone 2 to vary, thereby presenting a difficulty in stably measuring a sound from the determination target 1. The case where the determination target 1 is in motion is, for example, a case where the determination target 1 is placed on a belt conveyor and moving on a production line.

In contrast, the configuration of the fourth embodiment can cause the movable unit 13 to move according to the movement of the determination target 1 by the movable control unit 14. This can reduce or eliminate the change in the distance between the determination target 1 and the microphone 2, thereby enabling a sound from the determination target 1 to be stably measured.

Moreover, when the determination target 1 has a complex structure, it is likely that a long distance between the determination target 1 and the microphone 2 prevents obtaining a sufficient sound volume. Failure to obtain a sufficient sound volume means that waveform data having a sufficient amplitude is unobtainable. When waveform data having a sufficient amplitude is unobtainable, the waveform data may include no sound data required for the determination, which may result in a false determination. When the determination is made by the operator, the operator performs an inspection by bringing his or her ear close to the operation sound generating portion of the determination target 1. The configuration of the first embodiment has a difficulty in bringing the microphone 2 close to the operation sound generating portion of the determination target 1. In contrast, the configuration of the fourth embodiment can cause the movable unit 13 to move by the movable control unit 14 to allow the microphone 2 to be placed sufficiently near the operation sound generating portion of the determination target 1. This enables the microphone 2 to be placed to a closer position where a sufficient amplitude is obtainable to perform measurement. This enables waveform data having a sufficient amplitude to be obtained, and acceptability of the waveform data to be accurately determined.

As described above, the anomaly diagnosis device according to the fourth embodiment includes a movable unit for moving the microphone, and a movable control unit, which controls movement of the movable unit. This configuration allows the microphone to be brought close to the operation sound generating portion of the determination target. This enables waveform data having a sufficient amplitude to be obtained, and acceptability of the waveform data to be accurately determined.

### Fifth Embodiment

The configuration of the anomaly diagnosis device according to the first embodiment illustrated in FIG. 1 may allow an ambient noise to enter, and may cause the noise to be misidentified as an anomalous sound. In addition, when in an environment where ambient noise cannot be completely removed or noise enters continuously, the configuration of the second embodiment may cause misidentification of the noise as an anomalous sound. Moreover, when the operation sound generated from the determination target 1 has a large volume, the operation sound may be input also to the noise collecting microphones 11, which may cause the technique of the second embodiment to fail to estimate the time section in which noise is present. An improved technique that addresses these issues will thus be proposed in the description of a fifth embodiment. Note that the technique according to the fifth embodiment can be provided using the configuration of the anomaly diagnosis device 100 according to the first embodiment illustrated in FIG. 1.

An algorithm of an estimation process to be used in the fifth embodiment will next be described. First, the signal processing unit 4 performs STFT on the waveform data obtained by the conversion performed by the signal converter 3. In STFT, the waveform data is divided into an arbitrary number of blocks in each of the frequency direction and the time direction. This operation is the same as the operation performed in the first embodiment. The matrix F, i.e., the result of the STFT processing, is again given below by Equation (12) below.

$$Formula 12$$

$$F = [ \begin{matrix}{f}_{1 , 1} & … & {f}_{1 , j} \\ ⋮ & ⋱ & ⋮ \\ {f}_{i , 1} & … & {f}_{i , j}\end{matrix} ] \qquad ( 12 )$$

In Equation (12) above, “i” represents the number of divisions of the waveform data in the frequency direction, and “j” represents the number of divisions of the waveform data in the time direction.

The signal processing unit 4 calculates a matrix R expressed by Equation (13) below for the matrix F, which is the result of the STFT processing.

$$Formula 13$$

$$R = F \cdot ε \qquad ( 13 )$$

In Equation (13) above, & represents a matrix including the elements of the vector of the average υ expressed by Equation (4) above, and is expressed by Equation (14) below.

$$Formula 14$$

$$ε = [ \begin{matrix}{e}_{1 , 1} & … & 0 \\ ⋮ & ⋱ & ⋮ \\ 0 & … & {e}_{i , i}\end{matrix} ] \qquad ( 14 )$$

As given by Equation (14) above, the matrix ε is a diagonal matrix, and the diagonal elements thereof are expressed by Equation (15) below.

$$Formula 15$$

$${e}_{i , i} = \frac{1}{{v}_{i}} \qquad ( 15 )$$

As given by Equation (15) above, a diagonal element e_{i,i} of the matrix ε is expressed by a reciprocal of the average υᵢ.

The matrix R is calculated as information about the frequency of noise from a known normal product. In addition, the matrix R is expressed as a product of the matrix F and the matrix ε including the reciprocals of the averages υ as given by Equations (13) to (15) above, and is calculated as estimated values with respect to non-stationary noise. Note that when a sufficient number of averages υ have not been obtained, a unit matrix may be used instead of the matrix ε.

The signal processing unit 4 calculates a sum for each specific time period for each element of the matrix R, which represents an estimated value of non-stationary noise. A sum vector R′ can be expressed as Equation (16) below, where R′ represents a vector whose elements are the sums for each specific time period.

$$Formula 16$$

$${R}^{′} = [ {\sum }_{n = 1}^{i} {R}_{i , 1} … {\sum }_{n = 1}^{i} {R}_{i , j} ] \qquad ( 16 )$$

The signal processing unit 4 calculates the total average value of the sum vector R′, and identifies an element having a value greater than the total average value among the elements of the sum vector R′. The signal processing unit 4 then estimates that the section to which the element having a value greater than the total average value belongs is the time section in which non-stationary noise is present, i.e., the time section in which noise other than the operation sound is present. The techniques described in the first and second embodiments are applied to waveform data obtained by removal of the time section estimated. Such operation can provide a determination technique that reduces the effect of ambient noise.

Note that the above technique uses, but not limited to, the total average value of the sum vector R′ as the reference value, i.e., the threshold, for the comparison, but the threshold may instead be a product of multiplication of the total average value of the sum vector R′ by any factor.

As described above, according to the anomaly diagnosis device according to the fifth embodiment, the signal processing device estimates, using waveform data of an operation sound of a determination target, the time section in which noise other than the operation sound is present, performs short-time fast Fourier transform on waveform data obtained by removal of the time section estimated, and calculates feature quantities. This enables avoidance of misidentifying a noise included in a sound from the determination target as an anomaly.

In addition, the anomaly diagnosis method according to the fifth embodiment includes, between the second step and the third step of the anomaly diagnosis method described in the first embodiment, an estimation step of estimating, using waveform data of an operation sound of an electrical device, the time section in which noise other than the operation sound is present. Then, in the third step, short-time fast Fourier transform is performed on waveform data obtained by removal of the time section estimated in the estimation step, and the feature quantities are calculated. Such operation can provide a determination technique that reduces the effect of ambient noise. This enables avoidance of misidentifying a noise included in a sound from the determination target as an anomaly. Sixth Embodiment.

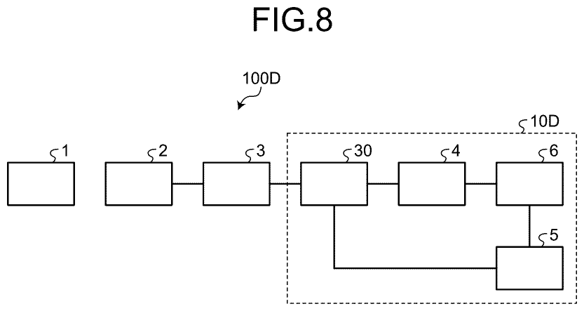

The configuration of the anomaly diagnosis device 100 according to the first embodiment illustrated in FIG. 1 may allow a known ambient noise to enter, and may cause the noise to be misidentified as an anomalous sound, where the known ambient noise includes, for example, a chime announcing the time and a melody generated by an automated guided vehicle (AGV) running in factory premises. In addition, when in an environment where ambient noise cannot be completely removed or noise enters continuously, the configuration of the second embodiment may cause misidentification of the noise as an anomalous sound. Moreover, when the operation sound generated from the determination target 1 has a large volume, the operation sound may be input also to the noise collecting microphones 11, which may cause the technique of the second embodiment to fail to estimate the time section in which noise is present. An improved technique that addresses these issues will thus be proposed in the description of a sixth embodiment. Note that the technique according to the sixth embodiment can be provided using an anomaly diagnosis device 100D including a signal processing device 10D, such as one illustrated in FIG. 8, instead of using the configuration of the anomaly diagnosis device 100 according to the first embodiment illustrated in FIG. 1. FIG. 8 is a block diagram illustrating an exemplary configuration of the anomaly diagnosis device 100D according to the sixth embodiment. The signal processing device 10D included in the anomaly diagnosis device 100D further includes a preprocessing unit 30 as compared with the configuration of the signal processing device 10 illustrated in FIG. 1. In addition, the data storage unit 5 of the signal processing device 10D stores the feature quantity data based on data of a known normal waveform, and known noise data.

An algorithm of an estimation process to be used in the sixth embodiment will next be described. First, the preprocessing unit 30 performs STFT on the waveform data obtained by the conversion performed by the signal converter 3 and on the known noise data. In STFT, the waveform data and the noise data are each divided into an arbitrary number of blocks in each of the frequency direction and the time direction. The preprocessing unit 30 also performs pattern matching between the matrices that are the respective results of the STFT processing.

Pattern matching can be performed using a commonly-used algorithm.

In this respect, the matrix representing the result of STFT from the waveform data obtained by the conversion performed by the signal converter 3 is denoted by I, and is referred to as “first signal matrix”. In addition, the matrix representing the result of STFT from the known noise data is denoted by T, and is referred to as “first noise matrix”. In pattern matching, normalized cross-correlation (R_{NCC}) expressed by Equation (17) below can be used, where M and N represent the respective sizes of the first noise matrix T in the time direction and in the frequency direction.

$$Formula 17$$

$${R}_{NCC} = \frac{{\sum }_{j = 0}^{N - 1} {\sum }_{i = 0}^{M - 1} I ( i , j ) T ( i , j )}{\sqrt{{\sum }_{j = 0}^{N - 1} {\sum }_{i = 0}^{M - 1} {I ( i , j )}^{2} \times {\sum }_{j = 0}^{N - 1} {\sum }_{i = 0}^{M - 1} {T ( i , j )}^{2}}} \qquad ( 17 )$$

When the normalized cross-correlation R_{NCC} obtained by pattern matching has, at a certain index pair (i, j), a value greater than a certain threshold Th_{Near} with respect to the degree of proximity, the preprocessing unit 30 presumes an index pair that provides the maximum value of the normalized cross-correlation R_{NCC} in the first signal matrix I obtained by the conversion performed by the signal converter 3 to be indicative of the start time, and then determines that data from this start time to the time corresponding to the size of the first noise matrix T in the time direction is the section in which known noise is present.

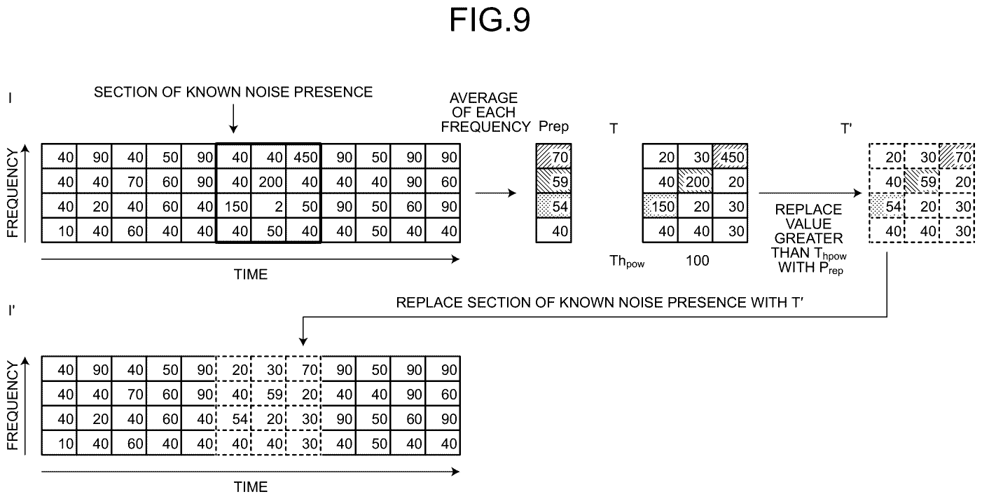

A procedure of removal of known noise will next be described with reference to FIG. 9. FIG. 9 is a diagram for describing a procedure of removal of known noise, performed using the anomaly diagnosis device 100D according to the sixth embodiment.

The preprocessing unit 30 determines whether the waveform data obtained by the conversion performed by the signal converter 3 includes known noise data. In the example of FIG. 9, the portion enclosed by the bold solid line is determined to be a section in which known noise is present.

When the preprocessing unit 30 has determined that there is a section in which known noise is present, the preprocessing unit 30 replaces each of the values of elements of the first noise matrix T greater than an element replacement threshold Th_{pow} with a value of a noise removal parameter Prep obtained through pattern matching, and generates a second noise matrix T′ having part of elements obtained by replacement of corresponding elements of the result of STFT from the known noise data. In the example of FIG. 9, the element replacement threshold Th_{pow}=100, and the values of “150”, “200”, and “450” greater than this value of 100 in the first noise matrix T are replaced with the values of the noise removal parameter Prep to thus generate the second noise matrix T′. In this operation, the values of the noise removal parameter Prep obtained through pattern matching can be the average values of the portion excluding the data of the section in which known noise is present in the first signal matrix I, or an uncalculated value. FIG. 9 illustrates an example in which the values of the noise removal parameter Prep are the average values of respective frequencies of the portion excluding the data of the section in which known noise is present in the first signal matrix I.

Finally, the preprocessing unit 30 replaces the data of the portion of the section in which known noise is present in the first signal matrix I with the second noise matrix T′ to thus generate the second signal matrix I′ having the effect of presence of the known noise having been eliminated. The processing of one of the first through fifth embodiments described above is thereafter performed using this second signal matrix I′.

Note that the sixth embodiment has been described in which the configuration additionally including the preprocessing unit 30 upstream of the signal processing unit 4 is applied to the configuration of the anomaly diagnosis device 100 according to the first embodiment illustrated in FIG. 1, but such configuration can also be applied to the configuration of the second embodiment illustrated in FIG. 4, the configuration of the third embodiment illustrated in FIG. 6, and the configuration of the fourth embodiment illustrated in FIG. 7.

As described above, according to the anomaly diagnosis device according to the sixth embodiment, the signal processing device includes a preprocessing unit that estimates, using known noise data, the time section in which the known noise data is present on the basis of the result of short-time fast Fourier transform, and the signal processing unit performs processing of calculating feature quantities from data excluding noise data. This enables avoidance of misidentifying a known noise included in a sound from the determination target as an anomaly.

In the anomaly diagnosis device according to the sixth embodiment, the preprocessing unit performs short-time fast Fourier transform on waveform data obtained by conversion performed by a signal converter and on known noise data. In STFT, the waveform data and the noise data are each divided into an arbitrary number of blocks in each of the frequency direction and the time direction. The preprocessing unit then performs pattern matching between matrices that are the respective results of processing of the short-time fast Fourier transform. In addition, the signal processing unit calculates first feature quantity data using data generated on the basis of the result of processing of the pattern matching performed by the preprocessing unit. Such operation can provide an anomaly diagnosis device that reduces the effect of ambient noise.

In addition, the anomaly diagnosis method according to the sixth embodiment includes, between the second step and the third step of the anomaly diagnosis methods described in the first through fifth embodiments, an estimation step of estimating the time section in which known noise data is present on the basis of the result of short-time fast Fourier transform. Then, in the third step, short-time fast Fourier transform is performed on waveform data obtained by replacement of data of the time section estimated in the estimation step with another data, and the feature quantities are calculated. Such operation can provide a determination technique that reduces the effect of ambient noise. This enables avoidance of misidentifying a noise included in a sound from the determination target as an anomaly.

The configurations described in the foregoing embodiments are merely examples. These configurations may be combined with another known technology, and configurations of different embodiments may be combined together. Moreover, part of such configurations may be omitted and/or modified without departing from the spirit thereof.

### REFERENCE SIGNS LIST

1 determination target; 2 microphone; 3 signal converter; 4 signal processing unit; 5 data storage unit; 6 determination unit; 10, 10D signal processing device; 11 noise collecting microphone; 12 sound insulation wall; 13 movable unit; 14 movable control unit; 21, 23 adder; 22 filter; 30 preprocessing unit; 100, 100A, 100B, 100C, 100D anomaly diagnosis device.

1. An anomaly diagnosis device comprising:
a microphone to convert a sound from a determination target into an analog electrical signal;
a signal converter to convert the analog electrical signal into a digital signal; and
a signal processor to receive the digital signal, and to perform signal processing, wherein
the signal processor comprises
a signal processing circuitry to perform short-time fast Fourier transform on waveform data of an input signal, to calculate feature quantities, and to perform a filter bank operation on the feature quantities generated,
a data storage circuitry to store feature quantity data based on data of a known normal waveform, and
a determination circuitry to compare first feature quantity data with second feature quantity data, and to determine acceptability of the waveform data of the input signal, the first feature quantity data consisting of a plurality ones of the feature quantities obtained through the filter bank operation, the second feature quantity data being the feature quantity data stored in the data storage circuitry, and
the feature quantities are each a quantity representing a degree of non-uniformity in temporal change of spectral intensity of a specific frequency band included in waveform data.

2. (canceled)

3. The anomaly diagnosis device according to claim 1, wherein
the signal processing circuitry performs short-time fast Fourier transform on waveform data obtained by conversion performed by the signal converter, and calculates a matrix F having “i” frequency dimensions and “j” time dimensions expressed by Equation (1) below, and calculates a feature quantity vector T expressed by Equation (2) below as the first feature quantity data, the feature quantity vector T including feature quantities that are standard deviations of spectral intensity in a time direction in the matrix F,
the data storage circuitry stores data with respect to an average υ and a standard deviation σ expressed by Equations (3) and (4) below as the second feature quantity data, the average υ and the standard deviation σ having been calculated on a basis of a set T′ₖ, the set T′ₖ being a set of feature quantities based on a plurality of sets of data of a known normal waveform, and
the determination circuitry determines whether the waveform data of the input signal has an anomaly on a basis of a degree of discrepancy between the first feature quantity data and the second feature quantity data.
$$Formula 1$$
$$F = [ \begin{matrix}{f}_{1 , 1} & … & {f}_{1 , j} \\ ⋮ & ⋱ & ⋮ \\ {f}_{i , 1} & … & {f}_{i , j}\end{matrix} ] \qquad ( 1 )$$
$$Formula 2$$
$$T = [ \begin{matrix}\sqrt{\frac{1}{j} {\sum }_{n = 1}^{j} {( {f}_{1 , n} - {\overline{f}}_{1} )}^{2}} \\ ⋮ \\ \sqrt{\frac{1}{j} {\sum }_{n = 1}^{j} {( {f}_{i , n} - {\overline{f}}_{l} )}^{2}}\end{matrix} ] \qquad ( 2 )$$
$$Formula 3$$
$$v = [ \begin{matrix}\frac{1}{k} {\sum }_{n = 1}^{k} {T}_{1}^{′} \\ ⋮ \\ \frac{1}{k} {\sum }_{n = 1}^{k} {T}_{i}^{′}\end{matrix} ] \qquad ( 3 )$$
$$Formula 4$$
$$σ = [ \begin{matrix}\sqrt{\frac{1}{k} {\sum }_{n = 1}^{k} {( {T}_{1}^{′} - \frac{1}{k} {\sum }_{n = 1}^{k} {T}_{1}^{′} )}^{2}} \\ ⋮ \\ \sqrt{\frac{1}{k} {\sum }_{n = 1}^{k} {( {T}_{i}^{′} - \frac{1}{k} {\sum }_{n = 1}^{k} {T}_{i}^{′} )}^{2}}\end{matrix} ] \qquad ( 4 )$$

4. The anomaly diagnosis device according to claim 3, comprising:
a noise collecting microphone for collecting ambient noise, wherein
the signal processor estimates a time section in which ambient noise is present, using waveform data collected using the noise collecting microphone, performs short-time fast Fourier transform on waveform data obtained by removal of the time section estimated, and calculates the feature quantities.

5. The anomaly diagnosis device according to claim 3, wherein
the signal processor estimates, using waveform data of an operation sound of the determination target, a time section in which noise other than the operation sound is present, performs short-time fast Fourier transform on waveform data obtained by removal of the time section estimated, and calculates the feature quantities.

6. The anomaly diagnosis device according to claim 3, wherein
the signal processor or comprises a preprocessing circuitry to estimate, using known noise data, a time section in which the known noise data is present on a basis of a result of short-time fast Fourier transform, and the signal processing circuitry performs short-time fast Fourier transform on waveform data obtained by replacement of data of the time section in which the known noise data is present with another data, and calculates the feature quantities.

7. The anomaly diagnosis device according to claim 6, wherein
the preprocessing circuitry performs short-time fast Fourier transform on the waveform data obtained by conversion performed by the signal converter and on the known noise data, and performs pattern matching between matrices that are respective results of processing of the short-time fast Fourier transform, in which the waveform data and the known noise data are each divided into an arbitrary number of blocks in each of a frequency direction and the time direction, and
the signal processing circuitry calculates the first feature quantity data using data generated on a basis of a result of processing of the pattern matching performed by the preprocessing circuitry.

8. The anomaly diagnosis device according to claim 7, wherein
a matrix representing the result of processing of the short-time fast Fourier transform performed on the waveform data is designated a first signal matrix, and a matrix representing the result of processing of the short-time fast Fourier transform performed on the known noise data is designated a first noise matrix,
when the waveform data includes the known noise data, the preprocessing circuitry determines that there is a section in which known noise is present, generates a second noise matrix, and generates a second signal matrix, the second noise matrix being obtained by replacement of a value of an element of the first noise matrix greater than a first threshold with a value of a noise removal parameter obtained through the pattern matching, the second signal matrix being obtained by replacement of data of a portion of the section in which known noise is present in the first signal matrix, with data of the second noise matrix, and
the signal processing circuitry calculates the first feature quantity data using the second signal matrix.

9. The anomaly diagnosis device according to claim 8, wherein
the preprocessing circuitry uses a normalized cross-correlation in the pattern matching between the first signal matrix and the first noise matrix, and when the normalized cross-correlation has a value greater than a second threshold for a certain index pair, the preprocessing circuitry presumes an index pair that provides a maximum value of the normalized cross-correlation in the first signal matrix to be indicative of a start time, and determines that data from this start time to a time corresponding to a size in the time direction of the first noise matrix is the section in which known noise is present.

10. The anomaly diagnosis device according to claim 3, comprising:
sound insulation walls arranged to surround the determination target.

11. The anomaly diagnosis device according to claim 3, comprising:
for mover for moving the microphone; and
a movable controller to control movement of the mover.

12. An anomaly diagnosis method for diagnosing an anomaly of an electrical device using a computer, the computer being configured to be able to refer to a feature quantity representing a degree of non-uniformity in temporal change of spectral intensity of a specific frequency band included in data of a known normal waveform, the anomaly diagnosis method comprising:
converting an operation sound of the electrical device into an analog electrical signal;
converting the analog electrical signal into a digital signal;
performing short-time fast Fourier transform on waveform data obtained by conversion performed in converting the digital signal, calculating feature quantities, and performing a filter bank operation on the feature quantities generated; and
comparing first feature quantity data with second feature quantity data, and determining acceptability of the waveform data, the first feature quantity data consisting of a plurality ones of the feature quantities obtained through the filter bank operation, the second feature quantity data being stored in the computer.

13. The anomaly diagnosis method according to claim 12, wherein
the anomaly diagnosis method comprises, between converting to the digital signal and performing the filter bank operation on the feature quantities generated, estimating a time section in which ambient noise is present, using waveform data collected using a noise collecting microphone for collecting the ambient noise, and
in performing the filter bank operation, short-time fast Fourier transform is performed on waveform data obtained by removal of the time section estimated in estimation the time section in which the ambient noise is present.

14. The anomaly diagnosis method according to claim 12, wherein
the anomaly diagnosis method comprises, between converting to the digital signal and performing the filter bank operation on the feature quantities generated, estimating, using waveform data of an operation sound of the electrical device, a time section in which noise other than the operation sound is present, and
in performing the filter bank operation, short-time fast Fourier transform is performed on waveform data obtained by removal of the time section estimated in estimating the time section in which the noise other than the operation sound is present.

15. The anomaly diagnosis method according to claim 12, wherein
the anomaly diagnosis method comprises, between converting to the digital signal and performing the filter bank operation on the feature quantities generated, estimating a time section in which known noise data is present on a basis of a result of short-time fast Fourier transform, and
in performing the filter bank operation, short-time fast Fourier transform is performed on waveform data obtained by replacement of data of the time section estimated in estimating the time section in which the known noise is present with another data.

16. A non-transitory computer-related storage medium having an anomaly diagnosis program stored therein, the anomaly diagnosis program causing a computer to diagnose an anomaly of an electrical device, the computer being configured to be able to refer to a feature quantity representing a degree of non-uniformity in temporal change of spectral intensity of a specific frequency band included in data of a known normal waveform, the anomaly diagnosis program causing the computer to perform processing comprising:
converting an operation sound of the electrical device into an analog electrical signal;
converting the analog electrical signal into a digital signal;
performing short-time fast Fourier transform on waveform data obtained by conversion performed in converting to the digital signal, calculating feature quantities, and performing a filter bank operation on the feature quantities generated; and
comparing first feature quantity data with second feature quantity data, and determining acceptability of the waveform data, the first feature quantity data consisting of a plurality ones of the feature quantities obtained through the filter bank operation, the second feature quantity data being stored in the computer.
